(19) United States
(12) Patent Application Publication
(10) Pub. No.: US 2022/0112909 A1
(43) Pub. Date: Apr. 14, 2022

(54) DEVICE MOUNTING SYSTEM, SECUREMENT SYSTEM, VERSATILE ACTION MOUNT DEVICE, A RETROFIT SYSTEM AND METHOD OF USE

(71) Applicants: Ryan Fleming, Purcellville, VA (US); Samuel Newberger, Leesburg, VA (US); Bradley Hess, Leesburg, VA (US)

(72) Inventors: Ryan Fleming, Purcellville, VA (US); Samuel Newberger, Leesburg, VA (US); Bradley Hess, Leesburg, VA (US)

(21) Appl. No.: 17/496,836

(22) Filed: Oct. 8, 2021

Related U.S. Application Data
(60) Provisional application No. 63/089,731, filed on Oct. 9, 2020.

(51) Int. Cl. F16B 1/00; G03B 17/56

(52) U.S. Cl. CPC F16B 1/00; F16B 2001/0035; G03B 17/561

(57) ABSTRACT

A device mounting system, a securement system, a versatile action mount device, and methods of use are presented. The present disclosure is a device mounting system for the versatile and secure mounting of action cameras. More specifically, and without limitation, the present disclosure is a versatile, two part magnetic action camera mount that provides securement for various types of cameras, among other features, functionality, and components. However, the present disclosure is not limited to these novel and inventive improvements, and it may further be adapted for a variety of purposes.

### CROSS-REFERENCE TO RELATED APPLICATIONS

The present application claims priority to the U.S. Provisional Patent Application No. 63/089,731 which was filed on Oct. 9, 2020, which is hereby incorporated by reference herein in its entirety, including any figures, tables, or drawings.

### FIELD OF THE DISCLOSURE

The present disclosure relates generally to a device mounting system, a securement system, a versatile action mount device, a retrofit system, and methods of use. More specifically, and without limitation, the present disclosure is a device mounting system for the versatile and secure mounting of action cameras. More specifically, and without limitation, the present disclosure is a versatile, two part magnetic action camera mount that provides securement for various types of cameras, among other features, functionality, and components. However, the present disclosure is not limited to these novel and inventive improvements, and it may further be adapted for a variety of purposes.

### COPYRIGHT NOTICE

At least a portion of the disclosure of this patent document contains material that is subject to copyright protection. The copyright owner has no objection to the facsimile reproduction by anyone of the patent document or the patent disclosure, as it appears in the Patent and Trademark Office patent files and/or records, but otherwise reserves all copyright rights whatsoever. The following notice applies to the software and data as described below and in the drawings that form a part of this document: Copyright Arc34 LLC. All rights reserved.

### BACKGROUND OF THE DISCLOSURE

Stabilization of cameras, and other tools are old and well known in the art. For some time, it has been desired to stabilize cameras and other devices for various reasons. This has to do with how cameras work and the various uses that a modern camera and/or camera phone has evolved into, in modern times.

Cameras are well known in the art. A camera is an optical tool which is used to record images. Cameras, generally speaking, are boxes with small holes (apertures) that allow a specified amount of light to enter the interior. Cameras have various mechanisms, such as digital sensors in a digital camera, that records the light entering the interior. In the case of a still photo, the camera and/or digital camera includes an aperture, a lens, a shutter, a viewfinder (in some cases), and often an electronic sensor for the capture of an image and/or images.

There are various types of cameras and cameras come in many forms, shapes, and sizes. Cameras may be standalone cameras. Cameras may be incorporated into smartphones and/or other devices, such as tablets. Furthermore, cameras can be various types of cameras. Many cameras may record still images on film. Other cameras may record video on rolls of film, or a plurality of single still pictures. Furthermore, other cameras, such as digital cameras, record information.

Because cameras rely on light entering the aperture, many require stabilization, especially action cameras. An action camera is a camera designed specifically for recording action while being immersed in it. Most action cameras are digital cameras. Also, because action cameras are designed to be immersed in action, they are generally designed to be compact and rugged. Personal action cameras have emerged more significantly in the art in recent years. For this reason, personal action cameras and the use of personal action cameras have demanded an amount of compactness and durability. For these reasons, and others, action cameras have been designed to be waterproof, handle high forces, handle motion, record in high definition, and include batteries, images sensors, among other functionalities and the like.

Action cameras are typically mounted or worn on a user in such a way that a user can get/obtain a desired shot. In this way, a user can capture an image and/or video from the point of view desired, often from the point of view of a user. Sometimes it is desirable to mount an action camera or the like on the helmet of a user, to the hat of a wearer, on the chest of a user, on the handlebars of a mountain bike, on the hood or side of a vehicle, or the like.

Action cameras, and camera mounts have existed in the art, but still have experienced much needed improvements. There is a long-felt need in the art for an easy to use mount which is reliable and which will stay in the position and location as intended. Many mounts existing in the art either fail to stay secured to the location and/or device they are attached to, or they fail to properly secure the camera and/or device which is attached to the mount.

These long felt needs and problems plaguing the art are amplified with action camera mounting because action cameras are associated with outdoor sports, often attached to helmets, surfboards, handlebars, vehicles, motorcycles, and the like so the cameras can be in the environment of the user, capturing activities being engaged by and/or with a user and/or plurality of users. It is apparent that a need exists for a novel solution to provide for a securable, reliable device mount which can be quickly moved, removed, adapted, adjusted, while maintaining the desired frame of capture.

Thus, the present disclosure is directed toward providing such a solution and more.

### SUMMARY OF THE DISCLOSURE:

The present disclosure relates generally to a device mounting system, a securement system, a versatile action mount device, and methods of use. More specifically, and without limitation, the present disclosure is a device mounting system for the versatile and secure mounting of action cameras. More specifically, and without limitation, the present disclosure is a versatile, two part magnetic action camera mount that provides securement for various types of cameras, among other features, functionality, and components. However, the present disclosure is not limited to these novel and inventive improvements, and it may further be adapted for a variety of purposes.

The purpose of this disclosure is to provide the state of the art with a device mounting system, a securement system, a versatile action mount device, and methods of use. More specifically, and without limitation, the present disclosure provides a system for securely mounting an action camera. More specifically, and without limitation, the present disclosure provides a system for making camera mounting easy. More specifically, and without limitation the present disclosure, provides for strapping and/or securely implementing camera mounting to successfully capture live action and/or images. However, the present disclosure is not limited to these novel and inventive improvements, and it may further be adapted for a variety of purposes.

More specifically, and without limitation, the present disclosure is a device with multi-function capability as both an adapter for securing the mount and/or other device to a location and as a securement device for the action camera and/or other device affixed to the mount. In this way, the present disclosure provides for a secure, and reliable mount which affixes accurately the device while securing the device reliably to any structure. Furthermore, the device can be removed and/or secured nearly instantaneously. In this way, the present disclosure provides solutions to ease of use, reliability, securement, speed, and many other factors that have been plaguing the art of device securement for some time.

Furthermore, the present disclosure offers convenient and safe securement for most modern electronics, including but not limited to, smartphones, tablets, laptops, action camera, cameras, speakers, and more. Furthermore, the present disclosure can be easily held by a single hand, easily adapted to an extension and the like. Furthermore, due to the unique design of the present disclosure, the mount can be securely attached to any magnetic material. Furthermore, due to the unique design of the present disclosure, the device can be securely attached to any material such as a swimsuit, a jacket, a fishing vest pocket, a t-shirt, or the like.

Additionally, the present disclosure is near instantaneous in connection, solving the long-felt need in the art of creating connections, mounting rigs, and the like that take a great deal of time and planning. The present disclosure provides a time and ease solution by instantaneous configuration. Additionally, the present disclosure is waterproof, military grade and features a rugged design such that the mount can handle extreme conditions. This solves an additional and long felt need of the art of mounts which require rigs and the like and can not handle fast moving air, fast moving water, pressure, temperature extremes, forces, and the like.

Furthermore, in combination with convenience, durability, reliance, the present disclosure provides the state of the art with all of these features in a compact size. Size has become more and more important in the art with the smaller the camera for convenience, this mount solves a long felt sizing issue facing the art along with these other solutions.

Additionally, the present disclosure, due to sizing and manufacturing developments, the design is more environmentally friendly than existing mounts. The present disclosure provides for the elimination of one use mounts and/or rigs that may need disposed of Furthermore, the present disclosure eliminates sticky pads which must be discarded and/or re-purchased from time to time, especially in the instance of relocating a mount and/or camera.

The present disclosure provides a system that can retrofit onto existing systems so that the existing system can become more user friendly. Said another way, the present disclosure also provides for a retrofit system that can be added to and/or modify existing action camera mounts so that the existing action camera mount can have the features, flexibility, and functionality of the present disclosure. In this way, the present disclosure provides adaptability and other additional features.

Taken individually, all the above provide for effective improvements upon the state of the art. Additionally, taken in combination, this disclosure provides for a convenient, easy to use, robust, reliable, and fast system and/or retrofit system and method of use that greatly improves upon the state of the art and/or provides a novel device and methodology for mounting and/or easily using action cameras.

Thus, it is a primary object of the disclosure to provide a device mounting system, a securement system, a versatile action mount device, a retrofit system, and methods of use that improve upon the state of the art.

Another object of the disclosure is to provide a device mounting system, a securement system, a versatile action mount device, a retrofit system, and methods of use that are environmentally friendly.

Yet another object of the disclosure is to provide a device mounting system, a securement system, a versatile action mount device, a retrofit system, and methods of use that are robust.

Another object of the disclosure is to provide a device mounting system, a securement system, a versatile action mount device, a retrofit system, and methods of use that are long-lasting.

Yet another object of the disclosure is to provide a device mounting system, a securement system, a versatile action mount device, a retrofit system, and methods of use that are easy to use.

Another object of the disclosure is to provide a device mounting system, a securement system, a versatile action mount device, a retrofit system, and methods of use that secure nearly instantaneously.

Yet another object of the disclosure is to provide a device mounting system, a securement system, a versatile action mount device, a retrofit system, and methods of use that are easy to hold.

Another object of the disclosure is to provide a device mounting system, a securement system, a versatile action mount device, a retrofit system, and methods of use that can be easily gripped by a user.

Yet another object of the disclosure is to provide a device mounting system, a securement system, a versatile action mount device, a retrofit system, and methods of use that can be gripped between two fingers of a user.

Another object of the disclosure is to provide a device mounting system, a securement system, a versatile action mount device, a retrofit system, and methods of use that are safe.

Yet another object of the disclosure is to provide a device mounting system, a securement system, a versatile action mount device, a retrofit system, and methods of use that work with existing systems.

Another object of the disclosure is to provide a device mounting system, a securement system, a versatile action mount device, a retrofit system, and methods of use that work with a variety of devices.

Yet another object of the disclosure is to provide a device mounting system, a securement system, a versatile action mount device, a retrofit system, and methods of use that are lightweight.

Another object of the disclosure is to provide a device mounting system, a securement system, a versatile action mount device, a retrofit system, and methods of use that are reusable.

Yet another object of the disclosure is to provide a device mounting system, a securement system, a versatile action mount device, a retrofit system, and methods of use that are comfortable for a user.

Another object of the disclosure is to provide a device mounting system, a securement system, a versatile action mount device, a retrofit system, and methods of use that work in a variety of sizes.

Yet another object of the disclosure is to provide a device mounting system, a securement system, a versatile action mount device, a retrofit system, and methods of use that are magnetic.

Another object of the disclosure is to provide a device mounting system, a securement system, a versatile action mount device, a retrofit system, and methods of use that secure to any ferrous material.

Yet another object of the disclosure is to provide a device mounting system, a securement system, a versatile action mount device, a retrofit system, and methods of use that easily attach to a shirt.

Another object of the disclosure is to provide a device mounting system, a securement system, a versatile action mount device, a retrofit system, and methods of use that includes a main housing for mounting and/or securing an action camera.

Yet another object of the disclosure is to provide a device mounting system, a securement system, a versatile action mount device, a retrofit system, and methods of use that includes a snap mount which is magnetic.

Another object of the disclosure is to provide a device mounting system, a securement system, a versatile action mount device, a retrofit system, and methods of use that can pivot.

Yet another object of the disclosure is to provide a device mounting system, a securement system, a versatile action mount device, a retrofit system, and methods of use that provide for adjustment to different angles.

Another object of the disclosure is to provide a device mounting system, a securement system, a versatile action mount device, a retrofit system, and methods of use that eliminates the need for a suction mount.

Yet another object of the disclosure is to provide a device mounting system, a securement system, a versatile action mount device, a retrofit system, and methods of use that includes a non-skid feature.

Another object of the disclosure is to provide a device mounting system, a securement system, a versatile action mount device, a retrofit system, and methods of use that provides for additional securement functionality for forces of detachment in all directions.

Yet another object of the disclosure is to provide a device mounting system, a securement system, a versatile action mount device, a retrofit system, and methods of use that protects the device the system is mounted to.

Another object of the disclosure is to provide a device mounting system, a securement system, a versatile action mount device, a retrofit system, and methods of use that turn any existing mount into a swappable mount.

Yet another object of the disclosure is to provide a device mounting system, a securement system, a versatile action mount device, a retrofit system, and methods of use that transforms an existing system into a swappable system.

Another object of the disclosure is to provide a device mounting system, a securement system, a versatile action mount device, a retrofit system, and methods of use that eliminates the need for screws.

Yet another object of the disclosure is to provide a device mounting system, a securement system, a versatile action mount device, a retrofit system, and methods of use that eliminates the need for screwing attachment.

Another object of the disclosure is to provide a device mounting system, a securement system, a versatile action mount device, a retrofit system, and methods of use that provide a quick swap magnetic system.

Yet another object of the disclosure is to provide a device mounting system, a securement system, a versatile action mount device, a retrofit system, and methods of use that provide a lanyard adapter system.

Another object of the disclosure is to provide a device mounting system, a securement system, a versatile action mount device, a retrofit system, and methods of use that provide for quick shot adaptation.

Yet another object of the disclosure is to provide a device mounting system, a securement system, a versatile action mount device, a retrofit system, and methods of use that provides for quick point of view shot adaptation which is near instantaneous.

Another object of the disclosure is to provide a device mounting system, a securement system, a versatile action mount device, a retrofit system, and methods of use that provide for stabilization.

Yet another object of the disclosure is to provide a device mounting system, a securement system, a versatile action mount device, a retrofit system, and methods of use that improves upon the film capturing of a variety of circumstances.

Another object of the disclosure is to provide a device mounting system, a securement system, a versatile action mount device, a retrofit system, and methods of use that are easy to transport.

Yet another object of the disclosure is to provide a device mounting system, a securement system, a versatile action mount device, a retrofit system, and methods of use that are convenient to use.

Another object of the disclosure is to provide a device mounting system, a securement system, a versatile action mount device, a retrofit system, and methods of use that can adapt to nearly every surface.

Yet another object of the disclosure is to provide a device mounting system, a securement system, a versatile action mount device, a retrofit system, and methods of use that are easy to manipulate.

Another object of the disclosure is to provide a device mounting system, a securement system, a versatile action mount device, a retrofit system, and methods of use that are relatively simple to use.

Yet another object of the disclosure is to provide a device mounting system, a securement system, a versatile action mount device, a retrofit system, and methods of use that improve upon the state of video capture.

These and other objects, features, or advantages of the present disclosure will become apparent from the specification and claims.

### BRIEF DESCRIPTION OF THE DRAWINGS

FIG. 1 is a top, perspective view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

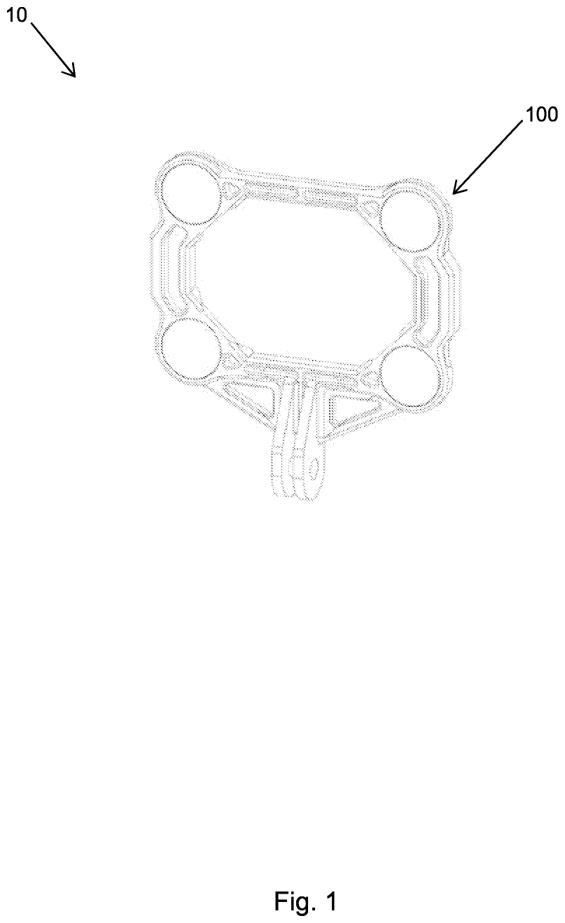

FIG. 2 is a top, perspective view showing the adapter system of the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

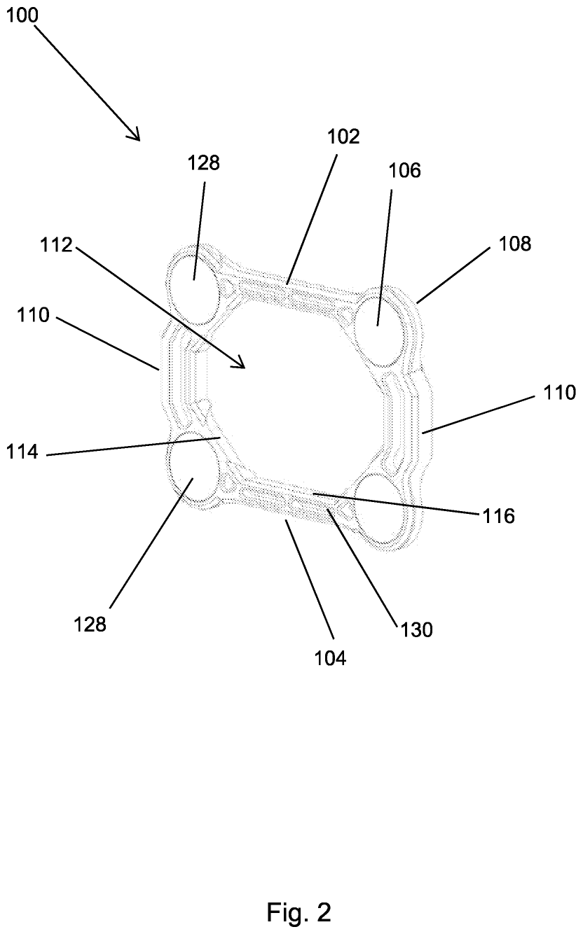

FIG. 3 is a top, perspective view showing an alternative embodiment of the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

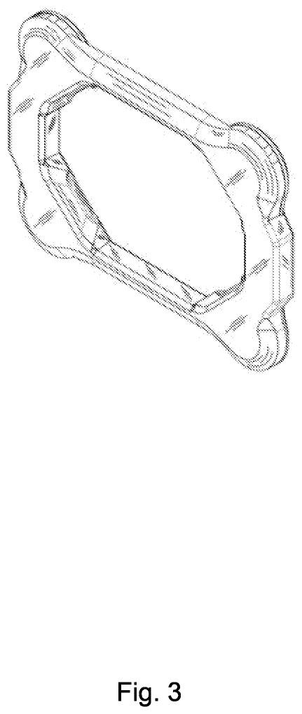

FIG. 4 is a front view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

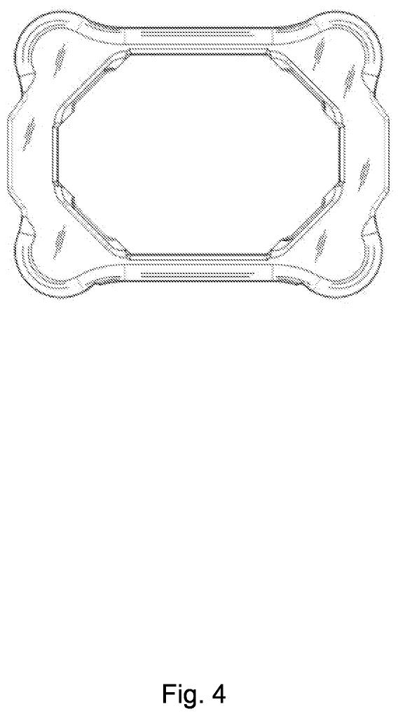

FIG. 5 is a side elevation view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

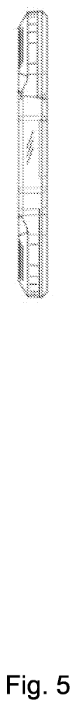

FIG. 6 is a bottom view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

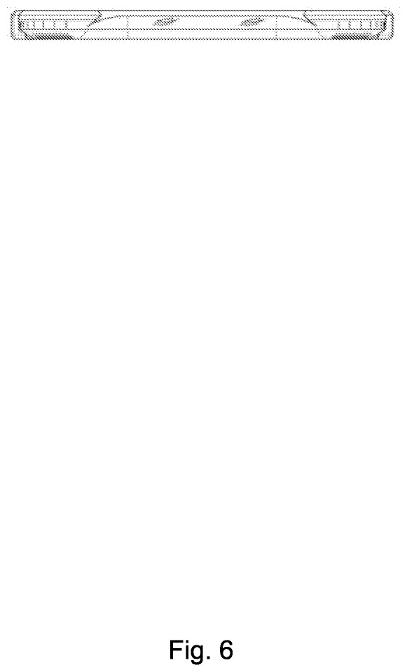

FIG. 7 is a top view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

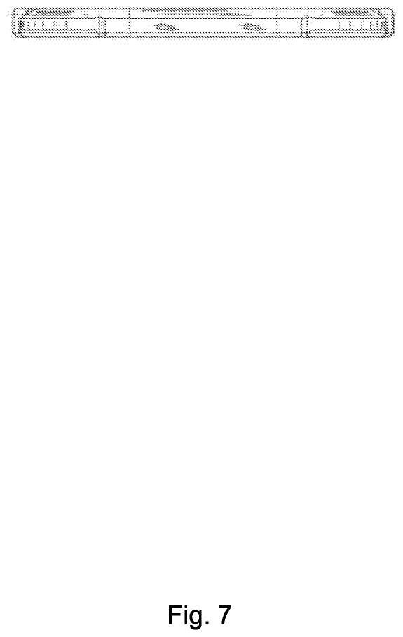

FIG. 8 is a rear view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

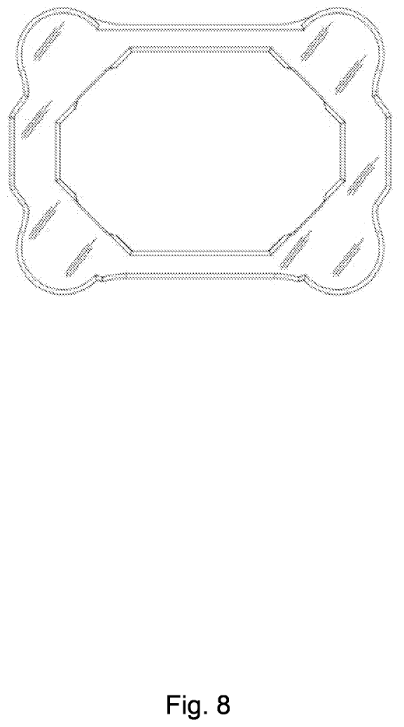

FIG. 9 is a bottom, perspective view showing the device mounting system, a securement system, a versatile action mount device, a retrofit system, and methods of use; the view showing a second piece for a mount system; the view showing a connection feature of the mount system; the view showing the secondary mount feature having a plurality of structural features; the view showing the secondary mount system having a plurality of magnets.

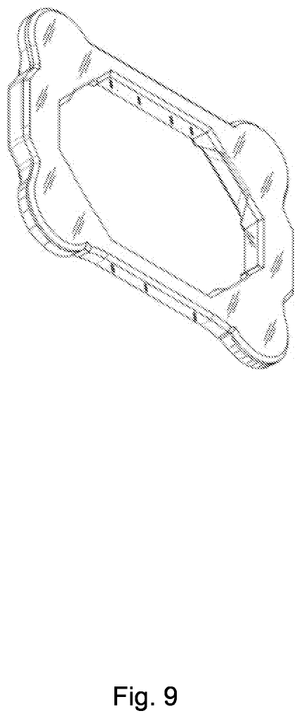

FIG. 10 is a top, perspective view showing an alternative embodiment of the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

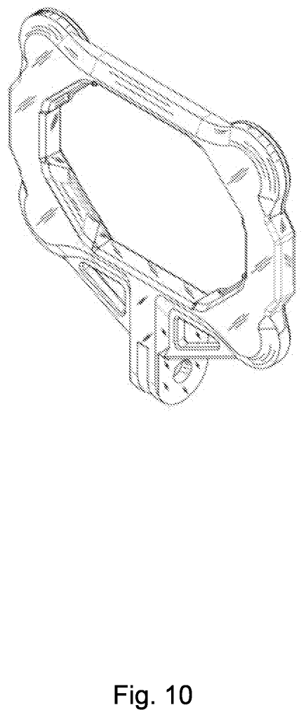

FIG. 11 is a front view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

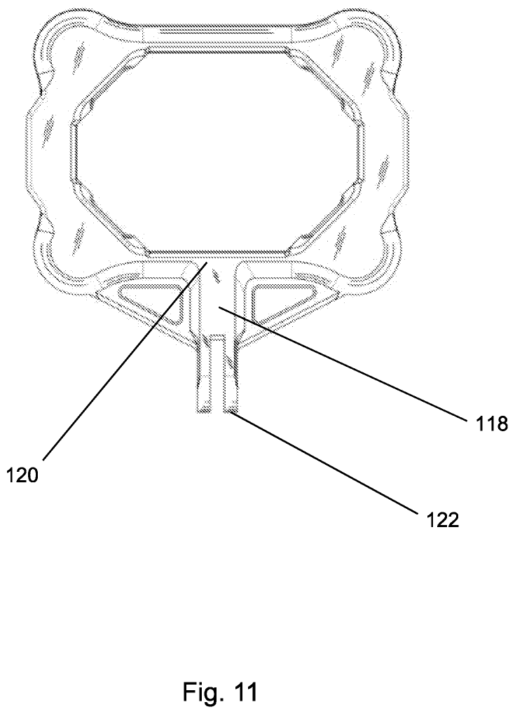

FIG. 12 is a side elevation view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

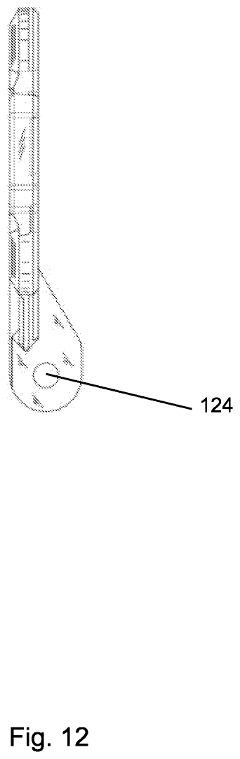

FIG. 13 is a top view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

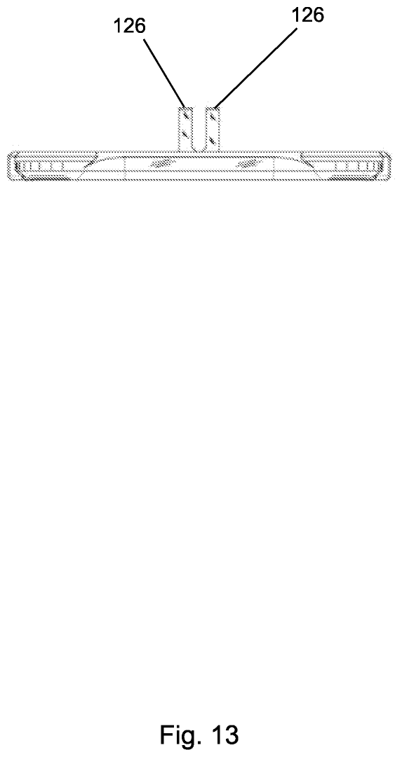

FIG. 14 is a bottom view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

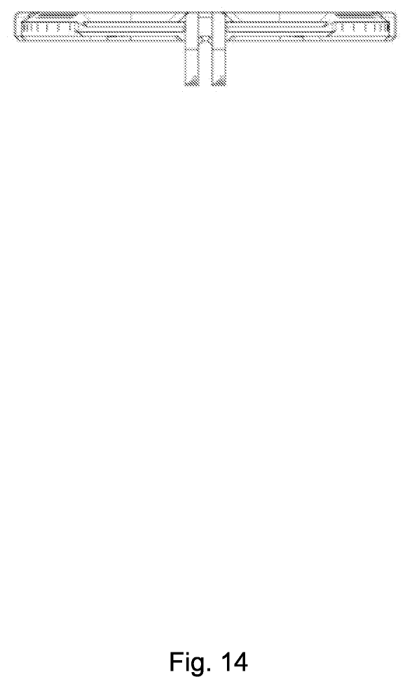

FIG. 15 is a rear view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

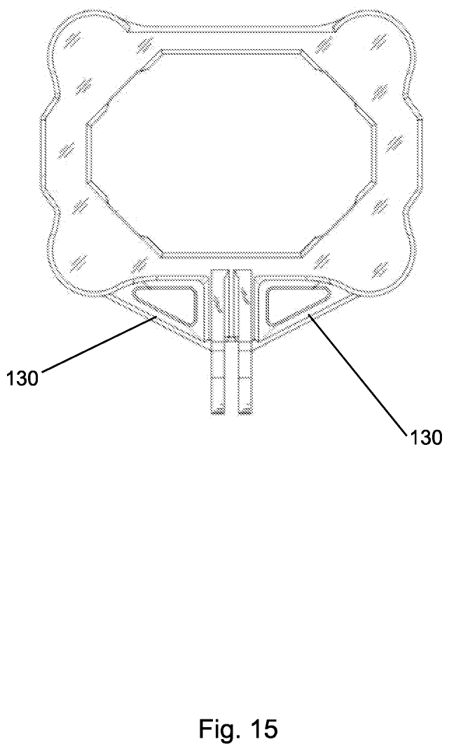

FIG. 16 is a bottom, perspective view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature.

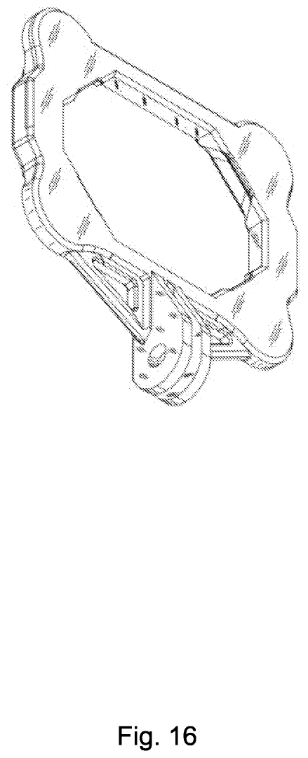

FIG. 17 is a top, perspective view showing another embodiment of the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

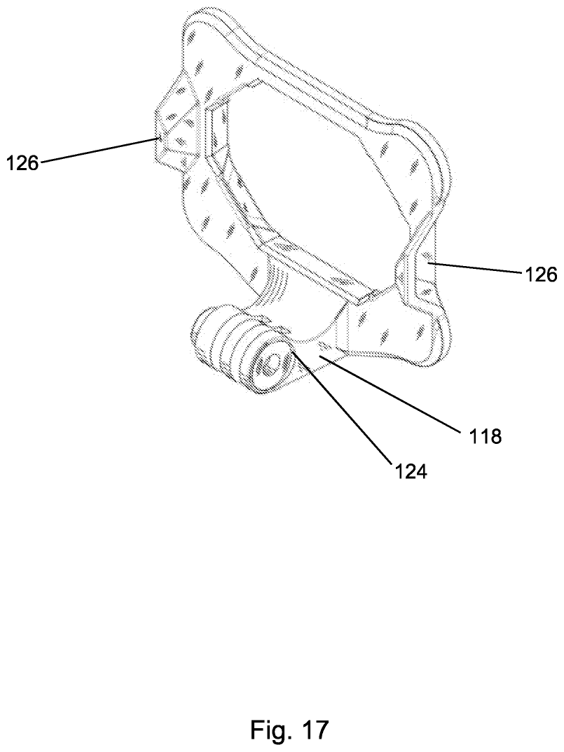

FIG. 18 is a front view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

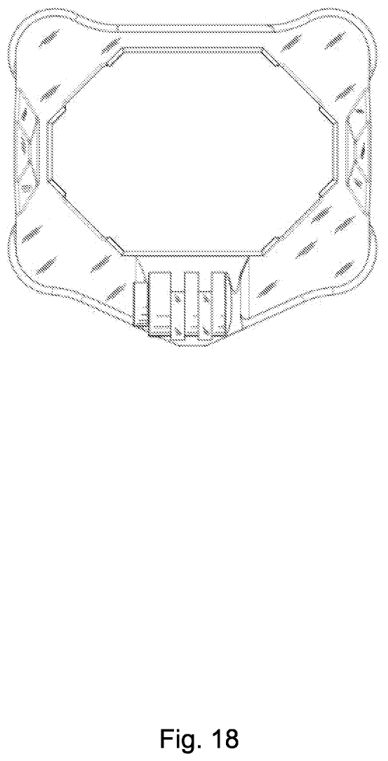

FIG. 19 is a side elevation view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

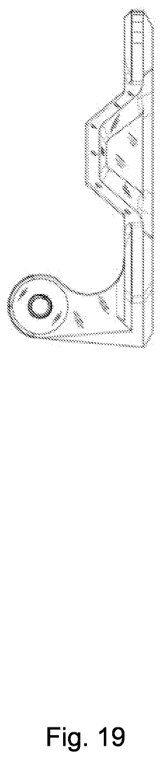

FIG. 20 is a side elevation view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

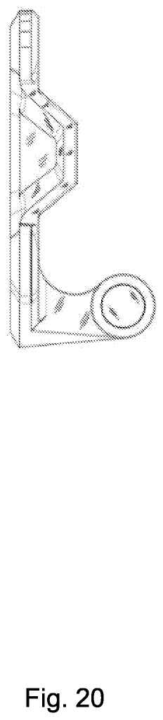

FIG. 21 is a top view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

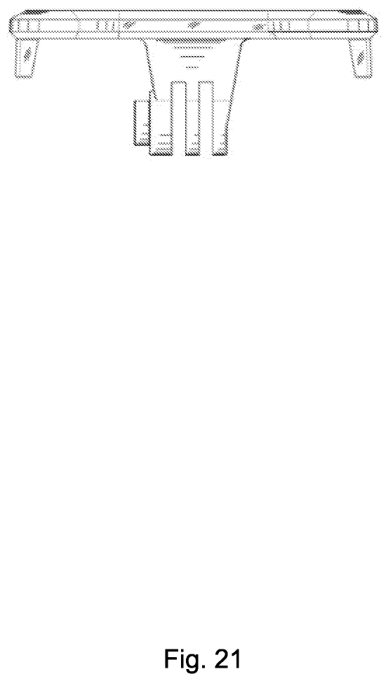

FIG. 22 is a bottom view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

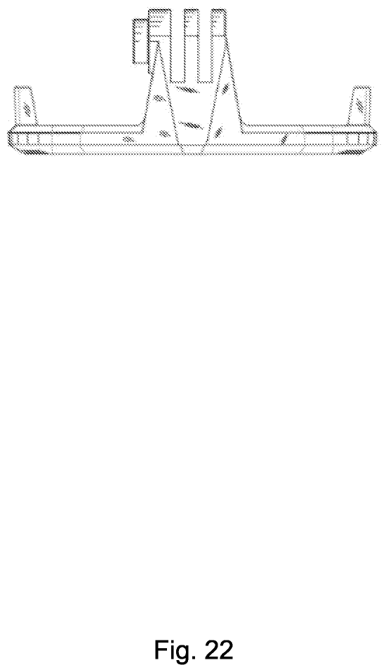

FIG. 23 is a rear view showing an alternative embodiment of the device mounting system, a securement system, a versatile action mount device, a retrofit system, and methods of use; the view showing a second piece for a mount system; the view showing a mount system; the view showing a mount system having a plurality of structural features; the view showing the mount system having a plurality of magnets; the view showing a connection tower; the view showing the connection tower having an attachment feature; the view showing a plurality of grip features.

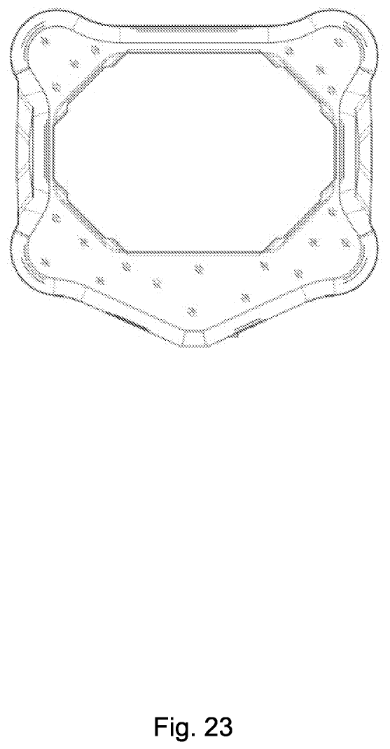

FIG. 24 is a bottom, perspective view showing the device mounting system, a securement system, a versatile action mount device, a retrofit system, and methods of use; the view showing a mount system; the view showing a mount system having a plurality of structural features; the view showing the mount system having a plurality of magnets; the view showing a connection tower; the view showing the connection tower having an attachment feature; the view showing a plurality of grip features.

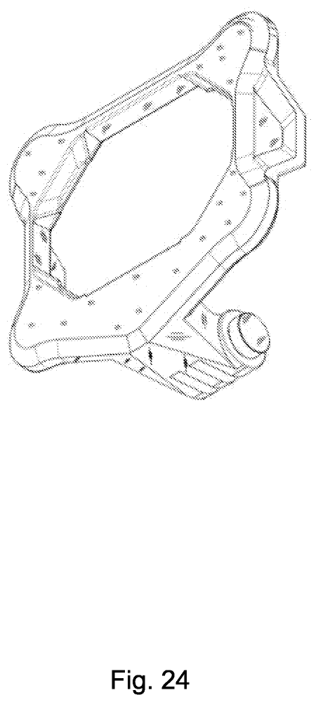

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure(s). The following detailed description is, therefore, not to be taken in a limiting sense, and the scope of the disclosure(s) is defined only by the appended claims, along with the full scope of equivalents to which such claims are entitled.

As used herein, the terminology such as vertical, horizontal, top, bottom, front, back, end, sides and the like are referenced according to the views, pieces and figures presented. It should be understood, however, that the terms are used only for purposes of description, and are not intended to be used as limitations. Accordingly, orientation of an object or a combination of objects may change without departing from the scope of the disclosure.

Reference throughout this specification to “one embodiment,” “an embodiment,” “one example,” or “an example” means that a particular feature, structure, or characteristic described in connection with the embodiment or example is included in at least one embodiment of the present disclosure. Thus, the appearance of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

All illustrations of the drawings are for the purpose of describing selected versions of the present disclosure and are not intended to limit the scope of the present disclosure.

Although the disclosure has been explained in relation to its preferred embodiment, it is to be understood that many other possible modifications and variations can be made without departing from the spirit and scope of the disclosure.

System:

With reference to the figures, a device mounting system, a securement system, a versatile action mount device, a retrofit system, and methods of use 10 are presented (also known as “snap system”, or “mounting system”, or “action camera mounting system”, or simply “system”). Action camera mounting system 10 is formed of any suitable size, shape and design and is configured to provide an easy to use mount which can be quickly adapted, retrofit onto existing systems and/or cameras, and make capturing images or video shots easy.

Additionally, the system 10 is configured to work with other devices so as to make devices more easy to use, such as using a camera phone on an extension stick to take pictures of oneself and friends, and the like. Similarly, system 10 is configured to provide a mounting system which can magnetically and swiftly attach to any one of a plurality of mounts, which are specially designed herein. Furthermore, the skid pad (to be discussed further herein) provides a unique stabilization feature to prevent sliding and the like, further enhancing system 10.

In the arrangement shown, as one example, system 10, includes a user or plurality of users, a mount system 100, an adapter system, and may also include a pad system, among other components, features, and functionality.

Additionally, system 10 may also include a surface, a structure, a material, a lanyard, a lanyard mount, an extension component, a telescoping pole, a chest mount, a backpack, a camera, an action camera, a smartphone, a tablet, a smart device, or other device, among other mounting surfaces and features, and various functionality and capabilities.

In the arrangement shown, as one example, device is not limited to an electronic device. Device may be any device which a user desires to secure, mount, or the like. In this way, device may be a notepad, a decoration, a watch, dinner plate, or the like. Device, in the arrangement shown, as one example, and for ease of explanation is explained using an action camera. This is strictly for ease of explanation herein.

User:

In the arrangement shown, as one example, system 10 includes user. User is typically a user engaging with the adapter system, the mount system, and the like, or wishing to attach the system 10 to a camera, an action camera, a smart phone, or the like.

In the arrangement shown, as one example, a user is an individual or group of individuals wishing to secure an action camera or other device to a surface and/or material. In this way, a user is an individual who is wishing to capture a particular shot and/or easily locate a camera in a particular position. Furthermore, a user may be an individual or group wishing to rapidly change a camera or other device's position and have a plurality of positioning capabilities. These and other uses of the system and ways in which a user can adapt and implement the system herein will be discussed further.

Mount System:

In the arrangement shown, as one example, system 10 includes a mount system 100. Mount system 100 is formed of any suitable size, shape, and design and is configured to accept and stabilize an action camera therein. Said another, the mount system 100 is configured to accept an action camera. In this way, the mount system 100 includes an attachment feature 124 (to be further discussed herein). The attachment feature of the mount system 100 is formed of any suitable size, shape, and design and is configured specifically to receive and/or adapt to receive an action camera, among other devices. In this way, the mount system 100 is configured to receive and stabilize an action camera, among other devices.

Additionally, the mount system is the primary connection piece of system 10. In this way, the mount system 100 may operate as a standalone device. The mount system 100 includes magnets and other features which provide a means of attaching an action camera and/or other device to a secure location. Said another way, the mount system 100 provides a means for attaching an action camera and/or other device to any ferrous material. Whether this is a part of a car and/or other vehicle, a bike and/or other transport device, another surface such as a fence, a panel, a chair, a wall, and/other locations, and the like. In this way, the mount system can quickly and easily secure an action camera and/or other device to a location. In this way, a user can capture shots and/or video of a desired image or video at a desired angle from a desired location in a safe, reliable, and efficient manner.

In the arrangement shown, as one example, the mount system 100 includes, but is not limited to, a top 102, a bottom 104, a first end 106, a second end 108, opposing sides 110, a hollow interior 112, an interior surface 116, a connection tower 118, a first end 120 of the connection tower 118, a second end 122 of the connection tower 118, an attachment feature 124—which may be of the connection tower 118 or a standalone attachment feature—a plurality of grips 126—of opposing sides in the figures shown—a plurality of magnets 128, a plurality of structural elements 130, and a plurality of stabilizers of the attachment feature 124, among other features, components, and the like.

In the arrangement shown, as one example, mount system 100 is formed of a plurality of types of polymers. Additionally, and in the arrangement shown, as one example, the mount system 100 is also formed of a metal composition, primarily portions of the interior of the structure are formed of a magnetic material which is strategically placed in the corners a specified distance from the edge. Additionally, and in the arrangement shown, as one example, portions of the mount system are formed of a metal with a thread pattern and/or a bolt for securement as part of an attachment device.

However, the mount system 100 may also be formed of other materials and components, such as but not limited to, having a coated material, a carbon fiber material, an enhanced polymer material, a polyvinyl chloride material or enhanced polyvinyl chloride, as well as from wood, and the like along with various coatings for appearance and design including but not limited to, finish material such as rose gold, gold leafing, gold, platinum, silver, wood, leather, and the like, and other finishing materials.

Furthermore, in the arrangement shown, as one example, the mount system 100 includes four strategically placed magnets. Each of these magnets have been placed according to extensive research and development. However, other magnet locations and numbers have also been contemplated for use including a single magnet, two magnets, three magnets, five magnets, six magnets, seven magnets, eight magnets, and the like. Additionally, various uses within the system for the types of magnets and arrangements of magnets have been contemplated for use and are hereby contemplated for structure and the like.

Additionally, and in the arrangement herein, as one example, the attachment feature is configured to accept and/or accommodate some of the common types of action cameras existing in the art today. However, a number of various attachment features, such as those for smart phones and other devices, are hereby contemplated for use. The arrangement shown, for action cameras, is shown for ease of explanation and as an example.

Adapter System:

In the arrangement shown, as one example, system 10 includes an adapter system. Adapter system is formed of any suitable size, shape, and design and is configured to accept and stabilize the mount system 100—and to accept and stabilize a secondary structure. The secondary structure may be a window mount with a suction cup. The secondary structure may be a bike mount with a secured attachment. The secondary structure may be a telescoping pole and/or telescoping device for extension purposes. The secondary structure may be a shirt, swimsuit, or other material like clothing device. The secondary structure may be a backpack, other pack, or the like. The secondary structure may be a helmet. These and other secondary structures are equipped to be held onto and/or secured by the adapter system. In this way, the adapter system provides the means for the mounting system 100 to be placed on a secondary structure. Said another way, the mount system 100 may be quickly removed from one secondary structure and rapidly placed onto a second secondary structure. Furthermore, the adapter system allows for quick removal from the second secondary structure and extremely quick—near instantaneous—connection to a third secondary structure.

In this way, the adapter system makes it possible for nearly any surface, material, or equipment to accept and stabilize an action camera therein through use of the adapter system and the mount system 100. Said another, the adapter system is configured to accept an action camera through the mount system 100. Furthermore, the adapter system, for the first time, provides for near instantaneous removal from one set up and quick adherence to another set up. Said another way, a user can rapidly pull the mount system 100 and any connected devices from the adapter system simply by breaking the magnetic connection created. The user can then quickly create a new magnetic bond with a second adapter system which is elsewhere to nearly instantly change the angle of capture of a camera and the like.

In this way, the adapter system includes an attachment feature (to be further discussed herein). The attachment feature of the adapter system is formed of any suitable size, shape, and design and is configured specifically to receive and/or adapt to receive a surface and/or secondary structure—such as a material or telescoping extension, or car mount, or bike mount, or helmet mount, or the like, among other devices. In this way, the adapter system is configured to receive and stabilize a mount system 100, a secondary system, and thus an action camera, among other devices.

Additionally, and in this way, the adapter system is the secondary connection piece of system 10. In this way, the adapter system works in harmony with the mount system 100 and any other surface and/or device to create near infinite possibilities of connections and/or adaptations of mounting, camera angles, placements, and instantaneous changes of such.

The adapter system includes magnets and other features which provide a means of attaching the mount system 100, and thus an action camera and/or other device to a secure location. Said another way, the adapter system 100 provides a means for attaching an action camera and/or other device to any ferrous material, surface, and the like.

Whether this is a part of a car and/or other vehicle, a bike and/or other transport device, another surface such as a fence, a panel, a chair, a wall, and/other locations, and the like. In this way, the adapter system can quickly and easily secure an action camera and/or other device to a location. In this way, a user can capture shots and/or video of a desired image or video at a desired angle from a desired location in a safe, reliable, and efficient manner.

In the arrangement shown, as one example, adapter system includes a top, a bottom, a first end, a second end, opposing sides, a hollow interior, an interior perimeter, an interior surface, a plurality of magnets, and a plurality of structural elements, among other features, components, and the like.

In the arrangement shown, as one example, the adapter system is formed of a plurality of types of polymers. Additionally, and in the arrangement shown, as one example, the adapter system is also formed of a metal composition, primarily portions of the interior of the structure are formed of a magnetic material which is strategically placed in the corners a specified distance from the edge. Additionally, and in the arrangement shown, as one example, portions of the adapter system are formed of a metal with a thread pattern and/or a bolt for securement as part of an attachment device.

However, the adapter system may also be formed of other materials and components, such as but not limited to, having a coated material, a carbon fiber material, an enhanced polymer material, a polyvinyl chloride material or enhanced polyvinyl chloride, as well as from wood, and the like along with various coatings for appearance and design including but not limited to, finish material such as rose gold, gold leafing, gold, platinum, silver, wood, leather, and the like, and other finishing materials.

Furthermore, in the arrangement shown, as one example, the adapter system includes four strategically placed magnets. Each of these magnets have been placed according to extensive research and development. However, other magnet locations and numbers have also been contemplated for use including a single magnet, two magnets, three magnets, five magnets, six magnets, seven magnets, eight magnets, and the like. Additionally, various uses within the system for the types of magnets and arrangements of magnets have been contemplated for use and are hereby contemplated for structure and the like.

Additionally, and in the arrangement herein, as one example, the attachment feature is configured to accept and/or accommodate some of the common types of action cameras existing in the art today. However, a number of various attachment features, such as those for smart phones and other devices, are hereby contemplated for use. The arrangement shown, for action cameras, is shown for ease of explanation and as an example.

Pad System:

In the arrangement shown, as one example, system 10 includes a pad system. Pad system is formed of any suitable size, shape, and design and is configured to stabilize mounting system 100 or adapter system and/or both systems simultaneously. In the arrangement shown, as one example, pad system is formed of a single, flat-like pad which is generally rectangular in shape. The pad, which is formed mostly of a high friction coefficient material is configured to prevent slipping, sliding, and the like between the mounting system 100 or adapter system and/or both systems simultaneously.

In the arrangement shown, as one example, the pad system can be placed between the mount system 100 and a surface. The magnets of the mount system 100 secure the pad with force between the mount system 100 and the surface. In this way, the pad system is held in place between the mount system 100 and the surface. Additionally, and in this way, the pad system provides for friction to prevent sliding and/or movement in any direction. This further secures the mount system 100 to any surface. Additionally, and in this way, the pad system prevents any potential scratching or rubbing which may otherwise occur if the pad system were not utilized.

In the arrangement shown, as one example, the pad system can be placed between the adapter system and a surface. The magnets of the adapter system secure the pad with force between the adapter system and the surface. In this way, the pad system is held in place between the adapter system and the surface. Additionally, and in this way, the pad system provides for friction to prevent sliding and/or movement in any direction. This further secures the adapter system to any surface. Additionally, and in this way, the pad system prevents any potential scratching or rubbing which may otherwise occur if the pad system were not utilized.

Furthermore, and in the arrangement shown, as one example, the pad system can be placed between the mount system 100 and a surface and/or the adapter system and a surface and/or the mount system 100 and an adapter system and a surface and/or a mount system 100 and a surface and an adapter system. Furthermore, in this way, multiple pad systems may be utilized for stability and protection.

In the arrangement shown, as one example, the pad system includes a top, a bottom, a first end, a second end, and an opposing side, among other features and components. Additionally, pad system may also include attachment features and magnets, and the like.

In Operation/Methods of Use:

In the arrangement shown, as one example, a user can secure a device to the mount system 100. Additionally the user can secure the mount system to any one of a plurality of surfaces. Additionally, the user can remove the mount system 100—and attached device—from a surface and re-attach to another surface. This process of use and operation can be repeated rapidly and to the user's content.

Adapter: In the arrangement shown, as one example, a user can secure a device to the mount system 100. Additionally, the user can attach the adapter system to a secondary device. Additionally, the user can secure the mount system 100 to the adapter system. Thus, a user can quickly attach a mount system 100—an attached device—to an adapter system and the connected secondary device. A plurality of adapter systems can be utilized, such that a user can rapidly attach and/or remove a single mount system 100 to any number of adapter systems attached to any number of secondary devices, such that a user can rapidly change the location of the mount system 100, the angle of the mount system 100, the orientation of the mount system 100 and the like. This operation and method of use can be repeated, efficiently, and near instantaneously due to the unique creation of the systems and inner workings.

Skid Pad: Furthermore, in operation with a pad system. A pad system can be utilized and located between a mount system 100 and surface, between a mount system 100 and adapter system, between a mount system 100 and a surface and an adapter system, and/or between an adapter system and a surface to prevent slippage, and provide friction and/or prevent scratching and the like.

Process of Manufacture:

In the arrangement shown, as one example, various processes of manufacture are hereby contemplated for use including a unique manufacturing process which was developed to completely hide and conceal the magnets and/or magnetic structure within the devices disclosed herein.

These manufacturing processes and other manufacturing processes as hereby contemplated for use are apparent in the figures depicted, which coincide with this description of the disclosure.

It will be appreciated by those skilled in the art that other various modifications could be made to the device without parting from the spirit and scope of this disclosure. All such modifications and changes fall within the scope of the claims and are intended to be covered thereby.

What is claimed:

1. A versatile action mount system, comprising:
a mount system;
the mount system having extending a length from a top to a bottom;
the mount system having opposing sides;
the mount system having a hollow interior;
the mount system having an interior perimeter with an interior surface;
the mount system having a connection tower;
the mount system having a first end and a second end;
the mount system having an attachment feature;
the mount system having a plurality of magnets;
wherein the mount system secures a device to a surface through magnetic engagement;
wherein the mount system is secured to the device by the attachment feature, the attachment feature being part of the connection tower.

2. The system of claim 1, further comprising:
wherein the mount system can rapidly attach to a device;
wherein the device is attached to the mount system by the connection tower;
wherein the mount system operably connects to the device by the attachment feature of the mount system.

3. The system of claim 1, further comprising:
wherein the mount system can rapidly attach to a device;
wherein the device is attached to the mount system by the connection tower;
wherein the mount system operably connects to the device by the attachment feature of the mount system;
wherein the device is an action camera.

4. The system of claim 1, further comprising:
wherein the mount system can rapidly attach to a device;
wherein the device is attached to the mount system by the connection tower;
wherein the mount system operably connects to the device by the attachment feature of the mount system;
wherein the device is a smart phone.

5. The system of claim 1, further comprising:
wherein the mount system can rapidly attach to a device;
wherein the device is attached to the mount system by the connection tower;
wherein the mount system operably connects to the device by the attachment feature of the mount system;
wherein the device is a camera.

6. The system of claim 1, further comprising:
a pad system;
the pad system having a first surface with a high coefficient of friction;
the pad system having a second surface with a high coefficient of friction;
wherein the pad system is placed between the mount system and a surface;
wherein the pad system prevents the mount system from sliding on the surface;
wherein the pad system prevents the mount system from moving;
wherein the pad system prevents the surface from becoming scratched or damaged by the mount system.

7. The system of claim 1, further comprising:
a pad system;
the pad system having a first surface with a high coefficient of friction;
wherein the pad system is placed between the mount system and a surface;
wherein the pad system prevents the mount system from moving.

8. The system of claim 1, further comprising:
a pad system;
the pad system having a first surface with a high coefficient of friction;
the pad system having a second surface with a high coefficient of friction;
wherein the pad system is placed between the mount system and a surface;
wherein the pad system prevents the mount system from moving;
wherein the pad system prevents the surface from becoming scratched or damaged by the mount system.

9. The system of claim 1, further comprising:
the mount system having a plurality of structural elements;
wherein the plurality of structural elements provide rigidity and stability to the mount system.

10. The system of claim 1, further comprising:
the mount system having a plurality of grips;
wherein the plurality of grips provide for ease in handling of the mount system.

11. The system of claim 1, further comprising:
an adapter system;
the adapter extending a length from a first end to a second end, having opposing sides, having a top and a bottom, having a hollow interior with an interior perimeter having an interior surface;
the adapter system having a plurality of magnets;
the adapter system having a plurality of structural features;
wherein the mount system rapidly secures to the adapter system;
wherein the mount system rapidly secures to the adapter system by a plurality of magnetic forces caused by the plurality of magnets.

12. The system of claim 1, further comprising:
an adapter system;
the adapter system having a plurality of features which engage with magnets;
the adapter system having a plurality of structural features;
wherein the mount system rapidly secures to the adapter system;
wherein the mount system rapidly secures to the adapter system by a plurality of magnetic forces caused by the plurality of magnets and the plurality of features which engage with magnets.

13. The system of claim 1, further comprising:
an adapter system;
the adapter extending a length from a first end to a second end, having opposing sides, having a top and a bottom, having a hollow interior with an interior perimeter having an interior surface;
the adapter system having a plurality of magnets;
the adapter system having a plurality of structural features;
wherein the mount system rapidly secures to the adapter system;
wherein the mount system rapidly secures to the adapter system by a plurality of magnetic forces caused by the plurality of magnets.

14. The system of claim 1, further comprising:
an adapter system;
the adapter extending a length from a first end to a second end, having opposing sides, having a top and a bottom, having a hollow interior with an interior perimeter having an interior surface;
the adapter system having a plurality of magnets;
wherein the mount system rapidly secures to the adapter system with a component therebetween;
wherein the mount system rapidly secures to the adapter system by a plurality of magnetic forces caused by the plurality of magnets.

15. A device mounting system, comprising:
a mount system;
the mount system having extending a length from a top to a bottom;
the mount system having opposing sides;
the mount system having an attachment feature;
the mount system having a plurality of magnets;
the mount system having a plurality of structural elements;
wherein the plurality of structural elements provide rigidity and stability to the mount system;
the mount system having a plurality of grips;
wherein the plurality of grips provide for ease in handling of the mount system;
wherein the mount system can rapidly attach to a device;
wherein the device is attached to the mount system by the connection tower;
wherein the mount system operably connects to the device by the attachment feature of the mount system;
wherein the mount system is secured to a location through magnetic engagement.

16. The system of claim 15, further comprising:
wherein the device is an action camera.

17. The system of claim 15, further comprising:
a pad system;
the pad system having a first surface with a high coefficient of friction;
the pad system having a second surface with a high coefficient of friction;
wherein the pad system is placed between the mount system and a surface;
wherein the pad system prevents the mount system from sliding on the surface;
wherein the pad system prevents the mount system from moving;
wherein the pad system prevents the surface from becoming scratched or damaged by the mount system.

18. The system of claim 15, further comprising:
an adapter system;
the adapter extending a length from a first end to a second end, having opposing sides, having a top and a bottom, having a hollow interior with an interior perimeter having an interior surface;
the adapter system having a plurality of magnets;
wherein the mount system rapidly secures to the adapter system;
wherein the mount system rapidly secures to the adapter system by a plurality of magnetic forces caused by the plurality of magnets.

19. The system of claim 15, further comprising:
an adapter system;
the adapter extending a length from a first end to a second end, having opposing sides, having a top and a bottom, having a hollow interior with an interior perimeter having an interior surface;
the adapter system having a plurality of magnets;
the adapter system having a plurality of structural features;
wherein the mount system rapidly secures to the adapter system with a component therebetween;
wherein the mount system rapidly secures to the adapter system by a plurality of magnetic forces caused by the plurality of magnets.

20. A method of use of securely mounting a device for capturing footage, the steps comprising:
providing a mount system having a plurality of magnets;
providing an adapter system having a plurality of magnetic features;
attaching the adapter system to a secondary device;
securing the mount system to the adapter system through magnetic engagement.
